(19) United States
(12) Patent Application Publication
(10) Pub. No.: US 2013/0262402 A1
(43) Pub. Date: Oct. 3, 2013

(54) Validating Data

(71) Applicants: Ronald G. Thomas, Houston, TX (US); Timothy D. Codd, Brighton, MI (US)

(72) Inventors: Ronald G. Thomas, Houston, TX (US); Timothy D. Codd, Brighton, MI (US)

(73) Assignee: Kaizen Logistics Services, LLC, Brighton, MI (US)

(21) Appl. No.: 13/779,810

(22) Filed: Feb. 28, 2013

Related U.S. Application Data
(60) Provisional application No. 61/619,680, filed on Apr. 3, 2012.

(51) Int. Cl. G06F 17/30

(52) U.S. Cl. CPC G06F 17/30371
USPC 707/690

(57) ABSTRACT

A method of validating data that includes receiving a bill of material and a part provisioning dataset and extracting at least one of part information from the bill of material or part provisioning information from the part provisioning dataset. The method further includes comparing the part information to the part provisioning information and determining a compatibility between the part information and the part provisioning information.

### CROSS REFERENCE TO RELATED APPLICATIONS

This U.S. patent application claims priority under 35 U.S.C. §119(e) to U.S. Provisional Application 61/619,680, filed on Apr. 3, 2012, which is hereby incorporated by reference in its entirety.

### TECHNICAL FIELD

This disclosure relates to validating data, such as a bill of material and/or part provisioning data.

### BACKGROUND

Integrated logistical support (ILS) generally entails the management of all activities needed to produce and support a system with a predetermined set of measurable objectives and an acceptable cost of ownership. Behind the scenes of an ILS operation is the creation and use of ideas using data and materials in a systems integration model. The ILS operation is the science and art of blending ideas and data to reach the goal of producing, supporting and maintaining any system that has been identified as a need to help the end user (front-line soldier). The overall goal of an ILS operation is to provide a system(s) to support the end user as quickly and accurately as possible within a reasonable cost.

### SUMMARY

One aspect of the disclosure provides a method of validating data (e.g., that may be stored in memory and executed on a competing processor). The method includes receiving a bill of material and a part provisioning dataset at a computing processor and extracting and storing in non-transitory memory at least one of part information from the bill of material or part provisioning information from the part provisioning dataset. The method further includes executing a comparison algorithm on the computing processor for comparing the part information to the part provisioning information and determining a compatibility between the part information and the part provisioning information.

Implementations of the disclosure may include one or more of the following features. In some implementations, the method includes, if the part information is compatible with the part provisioning information, storing an indicator in the non-transitory memory that the part information is compatible with the part provisioning information. If the part information is incompatible with the part provisioning information, the method may include storing an indicator in the non-transitory memory that the part information is incompatible with the part provisioning information.

In some implementations, the method includes, if the part information is compatible with the part provisioning information, communicating to a validation set that the part information is compatible with the part provisioning information. If the part information is incompatible with the part provisioning information, the method may include communicating to a validation set that the part information is incompatible with the part provisioning information.

In some examples, the method includes, if the part information is compatible with the part provisioning information, communicating to a validation set that at least one part in the part information is properly identified with a corresponding at least one part in the part provisioning information. If the part information is incompatible with the part provisioning information, the method may include communicating to a validation set that at least one part in the part information is erroneously identified with a corresponding at least one part in the part provisioning information.

In some examples, the method includes, if the part information is compatible with the part provisioning information, communicating to a validation set that at least one part of a part tree in the part information is properly identified with a corresponding at least one part of a part tree in the part provisioning information. If the part information is incompatible with the part provisioning information, the method may include communicating to a validation set that at least one part of a part tree in the part information is/are not properly identified with a corresponding at least one part of a part tree in the part provisioning information.

In some examples, the method includes, if the part information is compatible with the part provisioning information, communicating a reconciled part quantity to a part database. In some implementations, the method may also include communicating to a validation set at least one of: a cost of one or more parts or an availability of the one or more parts.

Another aspect of the disclosure provides a method of validating data. The method includes receiving a bill of material and a part provisioning dataset into non-transitory memory and extracting data related to at least one part identified in the bill of material and the part provisioning dataset. The method further includes determining if the extracted data related to the at least one part includes a parent-child relationship and determining if the parent-child relationship exists consistently in both the bill of material and the part provisioning dataset. The method may also include storing in the non-transitory memory an indicator of consistency of the parent-child relationship between the bill of material and the part provisioning dataset.

In some implementations, the method includes, after determining if the parent-child relationship exists consistently, storing the parent-child relationship in the non-transitory memory.

Yet another aspect of the disclosure provides a validation system. The validation system includes a file receiver for receiving and storing in the non-transitory memory part information from a bill of material and part provisioning information from a part provisioning dataset. The validation system can also include a validator for receiving an indicator of compatibility of the part information with the part provisioning information from the file receiver.

In some implementations, the validation system includes the file receiver having a parser that receives the bill of material and the part provisioning dataset. Subsequently, the parser parses the received bill of material and the received part provisioning dataset for determining the part information and the part provisioning information.

In some examples, the validation system includes an analyzer that determines the indicator of compatibility of the part information with the part provisioning information from the file receiver. Subsequently, the parser communicates the indicator of compatibility to the validator.

In some implementations, the validation system includes non-transitory memory that can be communicatively-coupled to at least one of the parser or the analyzer for storing the indicator of compatibility.

In some examples, the validation system includes a part database communicatively-coupled to the analyzer for communicating from the part database to the analyzer at least one of a cost of one or more parts or an availability of the one or more parts. The part database may include a part cost database portion and a part supply database portion.

Another aspect of the disclosure provides a computer program product encoded on a computer readable storage medium. The computer program product includes instructions that, when executed by a data processing apparatus, causes the data processing apparatus to perform operations. The operations include receiving a bill of material and a part provisioning dataset and extracting and storing in the non-transitory memory at least one of part information from the bill of material or part provisioning information from the part provisioning dataset. The operations may also include comparing the part information to the part provisioning information and executing a comparison algorithm on a computing processor for determining a compatibility between the part information and the part provisioning information.

In some implementations, if the part information is compatible with the part provisioning information, the operations include storing an indicator in the non-transitory memory that the part information is compatible with the part provisioning information. If the part information is incompatible with the part provisioning information, the operations may include storing an indicator in the non-transitory memory that the part information is incompatible with the part provisioning information.

In some implementations, if the part information is compatible with the part provisioning information, the operations include communicating to a validation set that the part information is compatible with the part provisioning information. If the part information is incompatible with the part provisioning information, the operations may include communicating to a validation set that the part information is incompatible with the part provisioning information.

In some implementations, if the part information is compatible with the part provisioning information, the operations include communicating to a validation set that at least one part in the part information is properly identified with a corresponding at least one part in the part provisioning information. If the part information is incompatible with the part provisioning information, the operations may include communicating to a validation set that at least one part in the part information is erroneously identified with a corresponding at least one part in the part provisioning information.

In some implementations, if the part information is compatible with the part provisioning information, the operations include communicating to a validation set that at least one part of a part tree in the part information is properly identified with a corresponding at least one part of a part tree in the part provisioning information. If the part information is incompatible with the part provisioning information, the operations may include communicating to a validation set that at least one part of a part tree in the part information is/are not properly identified with a corresponding at least one part of a part tree in the part provisioning information.

In some implementations, if the part information is compatible with the part provisioning information, the operations include communicating a reconciled part quantity to a part database. In some examples, the operations include communicating to a validation set at least one of: a cost of one or more parts or an availability of the one or more parts.

In some implementations, the operations include extracting data related to at least one part identified in the bill of material and the part provisioning dataset and determining if the extracted data related to the at least one part includes a parent-child relationship. The operations may also include determining if the parent-child relationship exists consistently in both the bill of material and the part provisioning dataset and storing an indicator of consistency of the parent-child relationship between the bill of material and the part provisioning dataset. In some examples, the operations include, after determining if the parent-child relationship exists consistently, storing the parent-child relationship in the non-transitory memory.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is schematic view of an exemplary validation system that produces a validation set from one or more data sources.

FIG. 2 is a schematic view of an exemplary validation system that produces the validation set from one or more data sources shown in FIG. 1.

FIG. 3A is a schematic view of an exemplary parser that produces a part information recordset.

FIG. 3B is a schematic view of an exemplary parser that produces a part provisioning recordset.

FIG. 4 is a schematic view of an exemplary parent-child relationship of a part found in one or more of part information recordset of FIG. 3A or the part provisioning recordset of FIG. 3B.

FIGS. 5-11 provide exemplary arrangements of operations for methods of a validating data.

Like reference symbols in the various drawings indicate like elements.

### DETAILED DESCRIPTION

A validation system (e.g., a comparison and/or reporting tool) may ensure that contractual data specified in a bill of material (BOM) accurately lists/represents part and/or system information provided in a part provisioning data set, such as a LSAR-036 Department of Defense file. The validation system may include a set of instructions stored in memory (e.g., non-transitory memory) and executed on a computing processor.

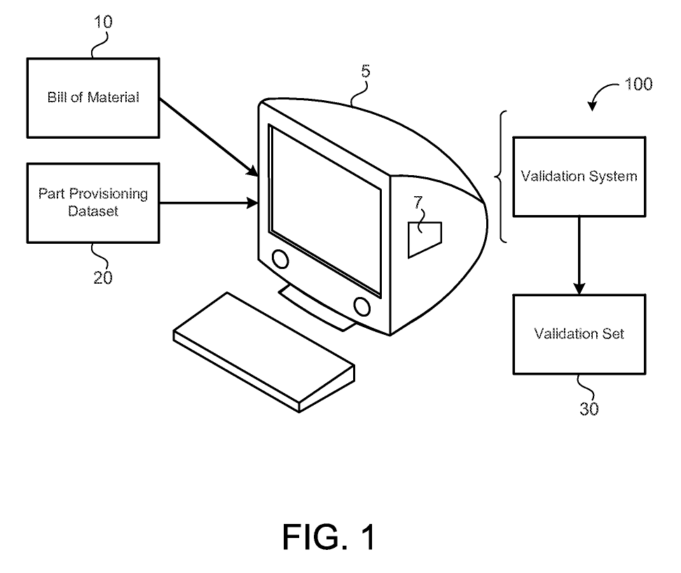

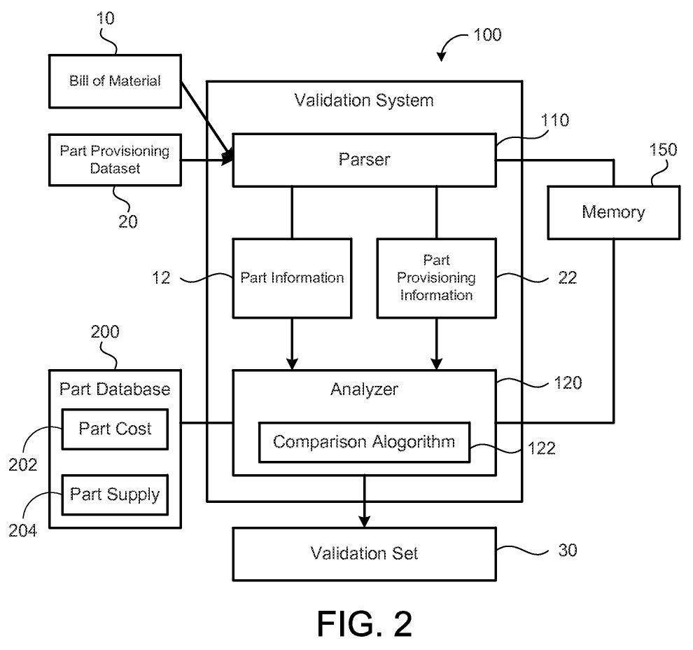

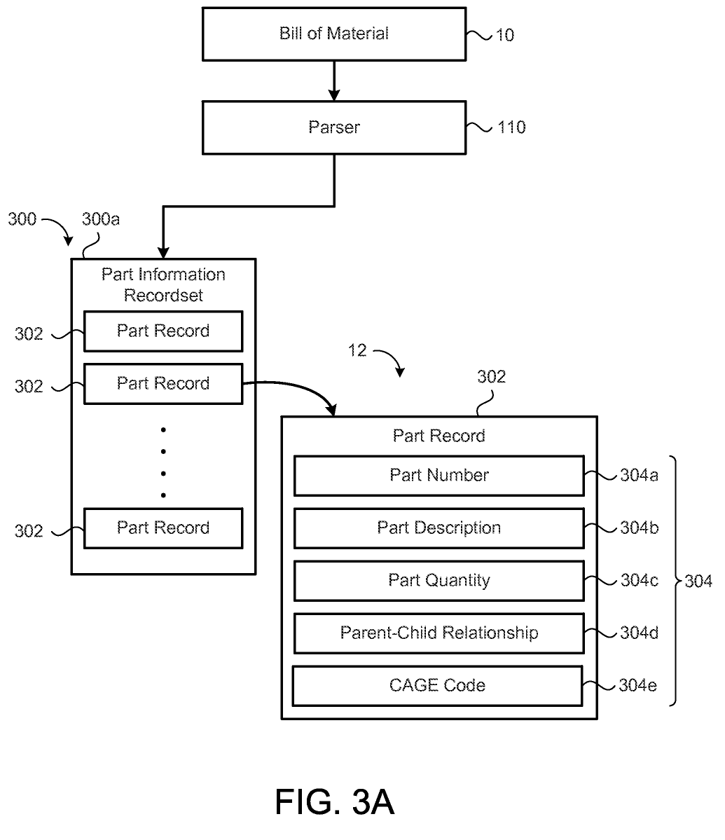

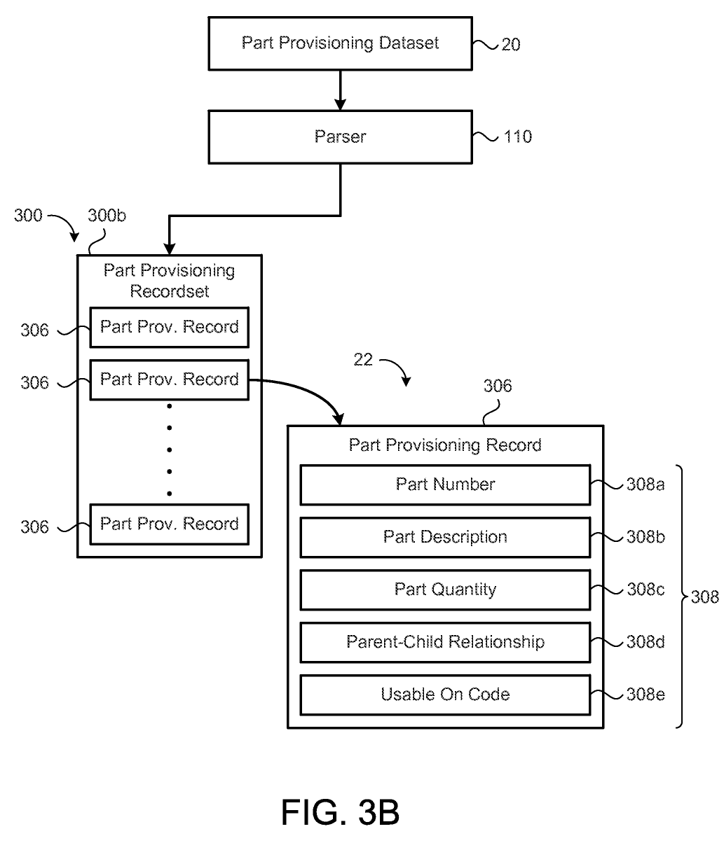

Referring to FIGS. 1 and 2, in some implementations, a validation system 100 receives a bill of material 10 (see also, e.g., FIG. 3A) and a part provisioning dataset 20 (see also, e.g., FIG. 3B), such as an LSAR-036 file, which is a specification generally used by the U.S. Department of Defense (DOD) for submitting part and systems provisioning data. The validation system 100 analyzes the bill of material 10 and the part provisioning dataset 20 to determine a validation set 30, which may provide a congruency, consistency, and/or compatibility between the bill of material 10 and the part provisioning dataset 20. In some implementations, the validation system 100 is a software application including a set of instructions and/or routines executable on a computing device 5 (e.g., a processor, a computer or handheld device) having non-transitory memory 7.

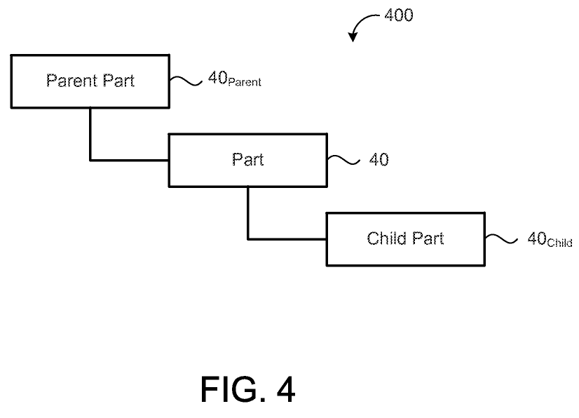

Referring to FIG. 4, the bill of material 10 may contain at least one part 40, which may be related to or have one or more child parts 40_{Child}. Moreover, the part 40 may be related to or have one or more parent parts 40_{Parent}. Accordingly, a relationship of the part 40 to the one or more child parts 40_{Child} and the one or more parent parts 40_{Parent} may be established in a “parent-child relationship tree” 400. Parent-child part relationships may assist in the identification of one or more components of an assembly or sub-assembly (i.e., an assembly or sub-assembly may include a part that comprises other parts). In other examples, the part 40 may or may not be related/belong to a parent part 40_{Parent} and may or may not be related to/have a child part 40_{Child}.

Referring to FIGS. 2 and 3A-3B, the validation system 100 may include a parser 110 that receives the bill of material 10 (e.g., as a data file) and identifies and/or extracts part information 12 from the bill of material 10. In the example shown in FIG. 3A, the parser 110 iteratively steps through each item of the bill of material 10 (e.g., each record of a recordset 300, each line of a text file, etc.) and identifies each part 40 located in the bill of material 10 and any accompanying information, such as, a part number 304a, part description 304b, Contractor and Government Entity (CAGE) code 304e, part quantity 304c, and/or a parent-child relationship 304d with another part (e.g., for assemblies and subassemblies). Similarly, as seen in FIG. 3B, the parser 110 may receive the part provisioning dataset 20 (e.g., as a data file) to identify and/or extract part provisioning information 22, such as a stocking number (e.g., national stocking number) 308a, descriptions 3080b, part quantities 308c, parent-child relationships 308d of parts (e.g., assemblies and subassemblies), and/or a usable-on-code (UOC) 308e. If the part provisioning dataset 20 (e.g., an LSAR-036 file) has more than one end item, the parser 110 may distinguish one end item from the other using the usable-on-code 308e.

The recordset 300 provided by the parser 110 may be a document object model (DOM), an extensible markup language (XML) object or file, and/or a JavaScript object notation (JSON) object containing the parsed information 304a-304e, 308a-308d. Additionally or alternatively, the parser 110 may store the recordset 300 containing the parsed information 304a-304e, 308a-308d in memory 150 (the memory 150 may be non-transitory memory located within the computing device 5, for example) and/or a database.

Referring to FIGS. 3A and 3B, in some implementations, the recordset 300 may be referred to as a parsed data file. The recordset 300 may be alternatively referred to as a part information recordset 300a (see, e.g., FIG. 3A) or a part provisioning information recordset 300b (see, e.g., FIG. 3B).

Referring to FIG. 3A, from the bill of material 10, the parser 110 may provide a part information recordset 300a having part records 302 with corresponding fields 304. Each part record 302 may include, but is not limited to, a part number 304a, a part description 304b, a part quantity 304c, a parent-child relationship 304d, and/or a CAGE code 304e.

Referring to FIG. 3B, from the part provisioning dataset 20, the parser 110 may provide a part provisioning information recordset 300b having part provisioning records 306 with corresponding fields 308. Each part provisioning record 306 may include, but is not limited to, a stocking number 308a, a description 308b, a part quantity 308c, and/or a parent-child relationship 308d.

Referring to FIG. 2, the validation system 100 may further include an analyzer 120 that receives, and optionally stores in memory 7, the part information 12, 304a-304e of the bill of material 10 and the part provisioning information 22, 308a-308d of the part provisioning dataset 20. The analyzer 120 then compares the part information 12, 304a-304e of the bill of material 10 with the part provisioning information 22, 308a-308d of the part provisioning dataset 20 in order to determine a compatibility or consistency therebetween. In some examples, for each part 40 identified in the part information 12. 304a-304e of the bill of material 10, the analyzer 120 tries to identify a corresponding part 40 in the part provisioning information 22, 308a-308d (e.g., by iterating through the part information recordset 300a and the part provisioning information recordset 300b). The analyzer 120 may execute a comparison algorithm 122 for determining a compatibility between the part information 12, 304a-304e of the bill of material 10 with the part provisioning information 22, 308a-304e of the part provisioning dataset 20. The analyzer 120 may, for example, determine a one-to-one correspondence for each identified part 40 by comparing the part information 12, 304a-304e of the bill of material 10 with the part provisioning information 22, 308a-304e of the part provisioning dataset 20 and subsequently recording (e.g., by storing in memory 150 and/or a database) consistencies and inconsistencies therebetween, such as whether the part descriptions 304b, 308b match, whether the part quantities 304c, 308c match, and/or whether the part 40 has a proper parent-child relationship 304d, 308d (if any).

Once the analyzer 120 determines the compatibility or consistency of the part information 12, 304a-304e of the bill of material 10 with the part provisioning information 22, 308a-308d of the part provisioning dataset 20, the analyzer 120 may communicate an output (e.g., data) to the validation set 30. In some examples, the analyzer 120 populates the validation set 30 with information related to the one-to-one correspondence for each identified part 40. The validation set 30 may be instantiated (e.g., by the parser 110 or the analyzer 120) as an empty recordset, a copy of the part information recordset 300a, a copy of the part provisioning information recordset 300b, or a merged copy of the part information recordset 300a and the part provisioning information recordset 300b.

The analyzer 120 may identify all erroneous parts 40, such as any parts 40 identified in the bill of material 10, but not in the part provisioning dataset 20; conversely, the analyzer 120 may identify all erroneous parts 40, such as parts 40 identified in the parts provisioning dataset 20, but not in the bill of material. Moreover, if the analyzer 120 properly identifies the part 40 in both the bill of material 10 and the part provisioning dataset 20, the analyzer 120 may determine if the part quantity 304c, 308c is consistent therebetween. The analyzer 120 may then populate the validation set 30 with the erroneously-identified part information and/or the properly identified part information.

For parts 40 that are part of a part tree 400, the analyzer 120 can search up and down a part tree 400 in both the bill of material 10 and the part provisioning dataset 20 to determine consistent part trees and identify any proper, improper, and/or broken tree structures. For example, the analyzer 120 may iterate through the part records 302 of the part information recordset 300a and the part provisioning records 306 of the part provisioning information recordset 300b, and, for each part 40, the analyzer 120 may compare the parent-child relationship 304d provided by the part information 12 with the parent-child relationship 308d provided by the part provisioning information 22. Upon determining one or more of the proper, improper and/or broken tree structures, the analyzer 120 may then populate the validation set 30 with the proper, improper and/or broken tree structure data.

The parser 110 may iteratively step through the bill of material 10 and the part provisioning dataset 20 to determine if each part 40 is a component of a parent part 40_{Parent} and/or if two or more child parts 40_{Child} form each part 40. Upon determining a parent relationship or a child relationship of the part 40, the parser 110 may then store the parent-child relationship (e.g., by storing a part ID or reference ID in a parent field and/or a child field, respectively) in memory 150. The analyzer 120 may then access the stored parent-child relationship in memory 150 in order to determine if any identified parent part 40_{Parent} and/or any identified child part 40_{Child} exists consistently in both the bill of material 10 and the part provisioning dataset 20. The analyzer 120 may store an indication of whether the parent-child relationships are correct or inconsistent in memory 150.

The analyzer 120 may communicate with a part database 200 (see, e.g., FIG. 2). The part database 200 may include one or both of a part cost database 202 and a part inventory database 204.

The cost database 202 may include cost data for one or more of the part 40, parent part 40_{Parent} and child part 40_{Child}. In some examples, once the analyzer 120 reconciles the part quantity 304c, 308c, the analyzer 120 may poll the cost database 202 for cost data for one or more of the part 40, parent part 40_{Parent} and child part 40_{Child}. Then, based upon, for example, the reconciled part quantity 304c, 308c the analyzer 120 may conduct a calculation step in order to calculate a cost of the reconciled part quantity 304c, 308c. In some implementations, the calculation may be itemized for one or more of the parts 40, parent part 40_{Parent} and child part 40_{Child}. The calculation may add the cost for two or more child parts 40_{Child} in order to determine a total cost of two or more child parts 40_{Child} that form a part 40. Additionally or alternatively, the calculation may add the cost for two or more parts 40 (that contribute to the formation of a parent part 40_{Parent}) in order to determine a total cost of a parent part 40_{Parent}. Upon calculating/determining the cost of the one or more of the part 40, parent part 40_{Parent} and child part 40_{Child}, the analyzer 120 may then populate the validation set 30 with the cost data.

The part inventory database 204 may include inventory data (i.e., part availability data) for one or more of the part 40, parent part 40_{Parent} and child part 40_{Child}. Alternatively, or, in addition to the inventory data, the part inventory database 204 may also include “commonality indicator” information/data of one or more of the part 40, parent part 40_{Parent} and child part 40_{Child}. The commonality indicator information/data may include, for example, classification data that classifies one or more of the part 40, parent part 40_{Parent} and child part 40_{Child} as a “common part” or an “uncommon part.” Upon calculating/determining the classification of one or more of the part 40, parent part 40_{Parent} and child part 40_{Child}, the analyzer 120 may then populate the validation set 30 with the part classification data.

A common part may be, for example, a mass-produced, off-the-shelf part, such as, for example, a threaded fastener. If the part inventory database 204 classifies one or more of the part 40, parent part 40_{Parent} and child part 40_{Child} as a common part, the inventory data may indicate, for example, that one or more of the part 40, parent part 40_{Parent} and child part 40_{Child} is available on an on-demand basis.

An uncommon part may be, for example, a non-off-the-shelf part. A non-off-the-shelf part may include, for example, a part that is not mass-produced, but, rather, may be manually manufactured by hand on a per-order basis. Because an uncommon part may not be readily available on an on-demand basis, the part inventory database 204 may include date-of-availability information (i.e., in some circumstances, the uncommon part may be available, for example, two weeks after being ordered and not on an on-demand basis). Accordingly, by indicating that one or more of the part 40, parent part 40_{Parent} and child part 40_{Child} may be an uncommon part, the classification of one or more of the part 40, parent part 40_{Parent} and child part 40_{Child} as an uncommon part may be utilized in order to qualify the inventory data for the purpose of forecasting when an uncommon part may be/will be available; by forecasting part availability, an increase in predictability of task completion may be realized such that one is not waiting for the uncommon part to become available, which may otherwise inhibit completion of an assembly task that requires the uncommon part.

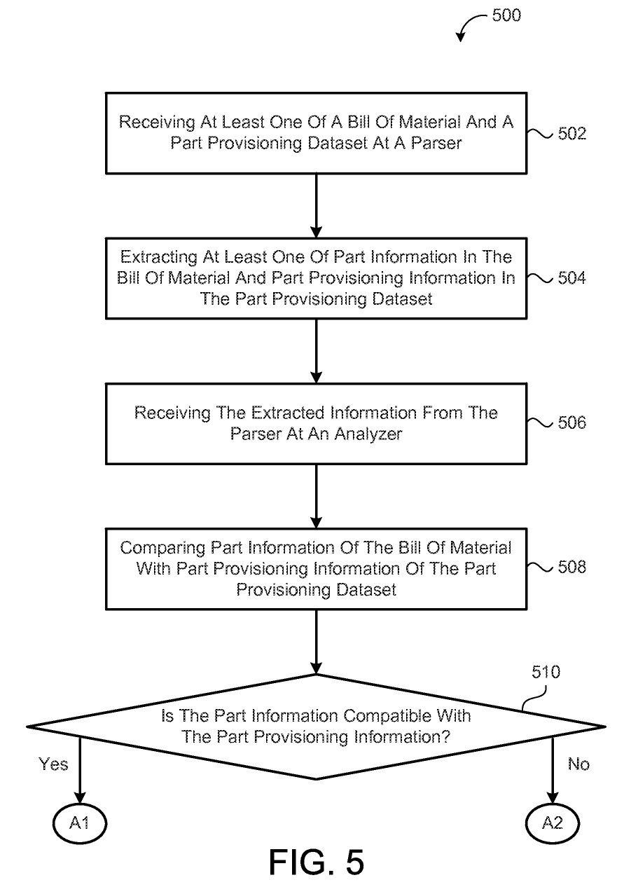

FIG. 5 provides an exemplary arrangement 500 of operations for a method of validating a bill of material 10 against a part provisioning dataset 20. The method may be a computer program (e.g., software application or code) that include machine instructions stored in memory 7 and executable on a programmable processor 5. A parser 110 of a validation system 100 receives 502 one or more of a bill of material 10 (e.g., as a data file) and a part provisioning dataset 20. The parser 110 identifies and/or extracts 504 one or more of part information 12 from the bill of material 10 and part provisioning information 22 from the part provision dataset 20. For example, the parser 110 may iteratively step through and extract 504 each item of the bill of material 10 (e.g., each record of a recordset 300, each line of a text file, etc.) and identify each part 40 located in the bill of material 10 and any accompanying information, such as a part number 304a, part description 304b, Contractor and Government Entity (CAGE) code 304e, part quantity 304c, and/or a parent-child relationship 304d with another part (e.g., for assemblies and subassemblies). Similarly, the parser 110 may identify and/or extract 504 part provisioning information 22, such as a stocking number (e.g., national stocking number) 308a, descriptions 3080b, part quantities 308c, and/or parent-child relationships 308d of parts (e.g., assemblies and subassemblies).

The recordset 300 (provided from the by parser 110 to the analyzer 120 as a result of the extraction step 502) may be a document object model (DOM), an extensible markup language (XML) object or file, and/or a JavaScript object notation (JSON) object containing the parsed information 304a-304e, 308a-308d. Additionally or alternatively, the parser 110 may store the recordset 300 containing the parsed information 304a-304e, 308a-308d in memory 150 (the memory 150 may be located within, for example, the computing device 5) and/or a database. In some implementations, the recordset 300 may be referred to as a parsed data file. The recordset 300 may be alternatively referred to as a part information recordset 300a or a part provisioning information recordset 300b. From the bill of material 10, the parser 110 may provide a part information recordset 300a having part records 302 with corresponding fields 304. Each part record 302 may include, but is not limited to, a part number 304a, a part description 304b, a part quantity 304c, a parent-child relationship 304d, and/or a CAGE code 304c. From the part provisioning dataset 20, the parser 110 may provide a part provisioning information recordset 300b having part provisioning records 306 with corresponding fields 308. Each part provisioning record 306 may include, but is not limited to, a stocking number 308a, a description 308b, a part quantity 308c, and/or a parent-child relationship 308d.

The validation system 100 may further include an analyzer 120 that receives 506 the extracted information from the parser 110 at step 504. The information received from the parser 110 at step 506 may include part information 12, 304a-304e of the bill of material 10 and the part provisioning information 22, 308a-308d of the part provisioning dataset 20. The analyzer 120 then compares 508 the part information 12, 304a-304e of the bill of material 10 with the part provisioning information 22, 308a-308d of the part provisioning dataset 20 in order to determine 510 a compatibility or consistency therebetween.

In some examples, for each part 40 identified in the part information 12, 304a-304e of the bill of material 10, the analyzer 120 identifies compatibility/non-compatibility 510 with a corresponding part 40 in the part provisioning information 22, 308a-308d (e.g., by iterating through the part information recordset 300a and the part provisioning information recordset 300b). The analyzer 120 may, for example, determine a one-to-one correspondence for each identified part 40 by comparing the part information 12, 304a-304e of the bill of material 10 with the part provisioning information 22, 308a-304e of the part provisioning dataset 20.

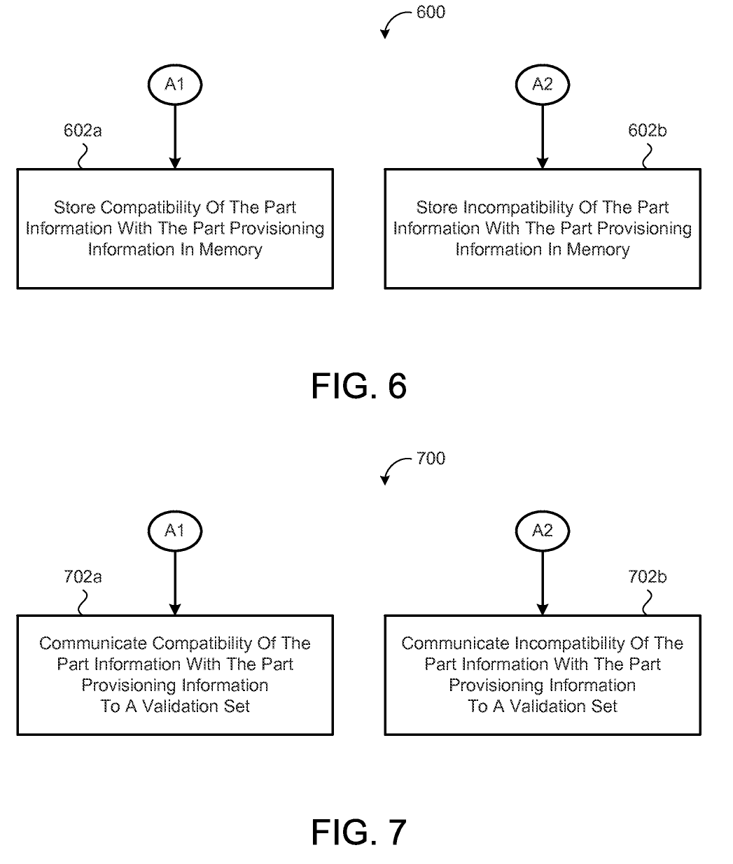

In an exemplary method 600, as seen in FIG. 6, once the analyzer 120 identifies a compatibility/non-compatibility 510 of each part 40 in the part information 12, 304a-304e of the bill of material 10, the analyzer 120 determines a corresponding part 40 in the part provisioning information 22, 308a-308d (i.e., step 510 of method 500 advances to either step 602a or 602b of method 600). The analyzer 120 may record 602a/602b the compatibility/non-compatibility 510 of the each part 40 identified in the part information 12, 304a-304e of the bill of material 10 to a corresponding part 40 in the part provisioning information 22, 308a-308d. The compatibility or non-compatibility (i.e., step 510 followed by step 602a) of each part 40 identified in the part information 12, 304a-304e of the bill of material 10 to a corresponding part 40 in the part provisioning information 22, 308a-308d may be stored 602a,602b in memory 150 and/or a database. An identified compatibility/non-compatibility at step 510 may be defined as a consistency/inconsistency of, for example, matching/mismatching of part descriptions 304b, 308b, matching/mismatching part quantities 304c, 308c, and/or proper/improper parent-child relationship 304d, 308d of a part 40.

In an exemplary method 700, as seen in FIG. 7, in response to determining compatibility/non-compatibility 510 of each part 40 identified in the part information 12, 304a-304e of the bill of material 10 to a corresponding part 40 in the part provisioning information 22, 308a-308d (i.e., step 510 of method 500 advances to either step 702a or 702b of method 700), the analyzer 120 may communicate 702a, 702b an output (e.g., data) to the validation set 30. In some examples, the analyzer 120 populates 702a the validation set 30 with information related to the one-to-one correspondence for each identified part 40; alternatively, the analyzer 120 populates 702b the validation set 30 with information related to the non-correspondence for each identified part 40. The validation set 30 may be instantiated (e.g., by the parser 110 or the analyzer 120) as an empty recordset, a copy of the part information recordset 300a, a copy of the part provisioning information recordset 300b, or a merged copy of the part information recordset 300a and the part provisioning information recordset 300b.

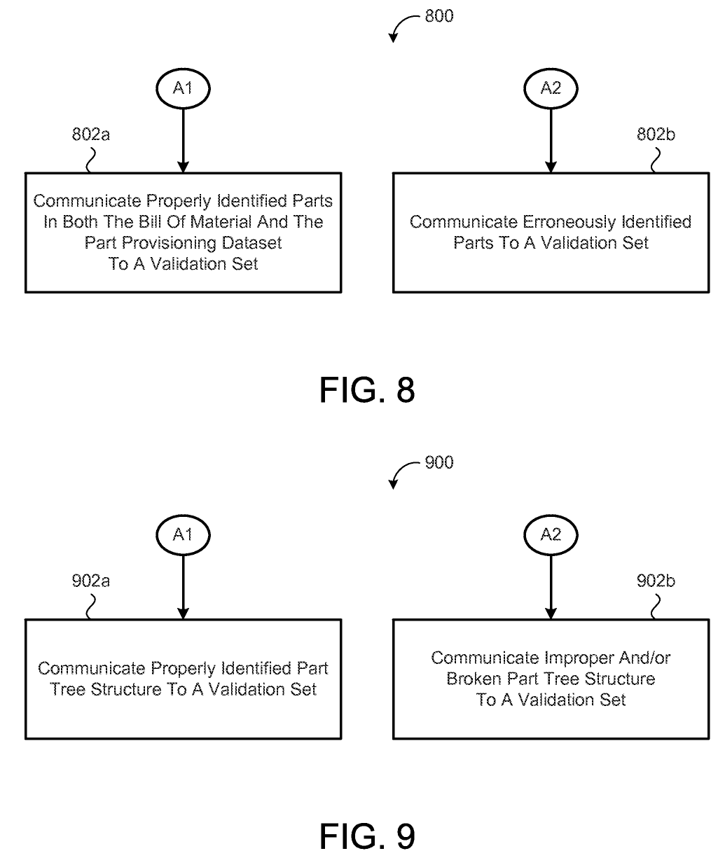

In an exemplary method 800, as seen in FIG. 8, in response to determining compatibility/non-compatibility 510 of each part 40 identified in the part information 12, 304a-304e of the bill of material 10 to a corresponding part 40 in the part provisioning information 22, 308a-308d (i.e., step 510 of method 500 advances to either step 802a or 802b of method 800), the analyzer 120 may communicate 802a or 802b an output (e.g., data) to the validation set 30. In some examples, the analyzer 120 communicates 802a to the validation set 30 parts 40 properly identified in both of the bill of material 10 and the part provisioning dataset 20. In additional examples, the analyzer 120 communicates 802b to the validation set 30 parts 40 that were erroneously identified in one of the bill of material 10 and the part provisioning dataset 20. The analyzer 120 may identify all erroneous parts 40, such as any parts 40 identified in the bill of material 10, but not in the part provisioning dataset 20; conversely, in some examples, the analyzer 120 may identify all erroneous parts 40, such as parts 40 identified in the parts provisioning dataset 20, but not in the bill of material. Moreover, if the analyzer 120 properly identifies the part 40 in both the bill of material 10 and the part provisioning dataset 20, the analyzer 120 may determine if the part quantity 304c, 308c is consistent therebetween. The analyzer 120 may then populate 802b the validation set 30 with the erroneously-identified part information and/or the properly identified part information.

In an exemplary method 900 as seen in FIG. 9, once the analyzer 120 determines compatibility/non-compatibility 510 of the each part 40 identified in the part information 12, 304a-304e of the bill of material 10 to a corresponding part 40 in the part provisioning information 22, 308a-308d, (i.e., step 510 of method 500 advances to either step 902a or 902b of method 900), the analyzer 120 may communicate 902a or 902b an output (e.g., data) to the validation set 30. For parts 40 that are part of a part tree 400, the analyzer 120 can search up and down a part tree 400 in both the bill of material 10 and the part provisioning dataset 20 to determine consistent part trees and identify any proper, improper, and/or broken tree structures. For example, the analyzer 120 may iterate through the part records 302 of the part information recordset 300a and the part provisioning records 306 of the part provisioning information recordset 300b, and, for each part 40, the analyzer 120 may compare the parent-child relationship 304d provided by the part information 12 with the parent-child relationship 308d provided by the part provisioning information 22; upon determining one or more of the proper, improper and/or broken tree structures, the analyzer 120 may then populate 902a/902b the validation set 30 with the proper, improper and/or broken tree structure data.

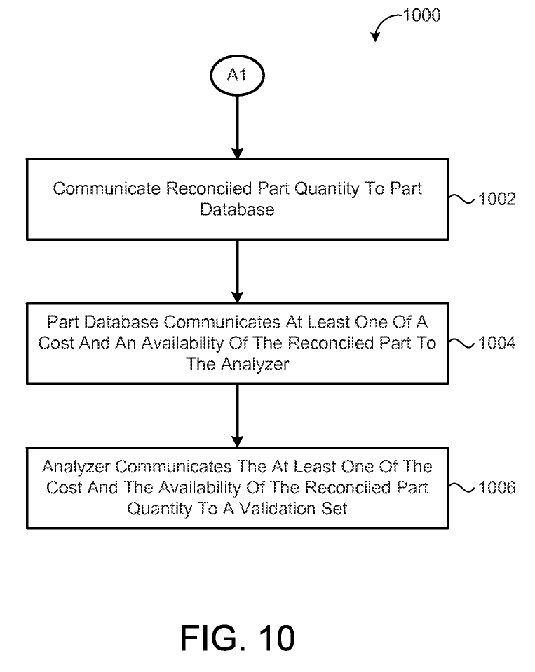

In an exemplary method 1000 as seen in FIG. 10, once the analyzer 120 determines compatibility/non-compatibility 510 of the each part 40 identified in the part information 12, 304a-304e of the bill of material 10 to a corresponding part 40 in the part provisioning information 22, 308a-308d, (i.e., step 510 of method 500 advances to step 1002 of method 1000), the analyzer 120 may communicate 1002 with a part database 200. The part database 200 may include one or both of a part cost database 202 and a part inventory database 204.

The cost database 202 may include cost data for one or more of the part 40, parent part 40_{Parent} and child part 40_{Child}. In some examples, once the analyzer 120 reconciles the part quantity 304c, 308c, as described above, the analyzer 120 may poll 1002 the cost database 202 for cost data for one or more of the part 40, parent part 40_{Parent} and child part 40_{Child}. Then, based upon, for example, the reconciled part quantity 304c, 308c, the analyzer 120 may conduct a calculation step in order to calculate a cost of the reconciled part quantity 304c, 308c based upon cost information communicated 1004 from the cost database 202 to the analyzer 120. In some examples, the calculation may be itemized for one or more of the parts40, parent part 40_{Parent} and child part 40_{Child}. In some instances, the calculation may add the cost for two or more child parts 40_{Child} in order to determine a total cost of a part 40 that is formed by the two or more child parts 40_{Child}. In some implementations, the calculation may add the cost for two or more parts 40 (that contribute to the formation of a parent part 40_{Parent}) in order to determine a total cost of a parent part 40_{Parent}. Upon calculating/determining the cost of the one or more of the part 40, parent part 40_{Parent} and child part 40_{Child}, the analyzer 120 may then populate 1006 the validation set 30 with the calculated cost data.

The part inventory database 204 may include inventory data (i.e., part availability data) for one or more of the part 40, parent part 40_{Parent} and child part 40_{Child}. Alternatively, or, in addition to the inventory data, the part inventory database 204 may also include “commonality indicator” information/data of one or more of the part 40, parent part 40_{Parent} and child part 40_{Child}. The commonality indicator information/data may include, for example, classification data that classifies one or more of the part 40, parent part 40_{Parent} and child part 40_{Child} as a “common part” or an “uncommon part.” Upon calculating/determining the classification of one or more of the part 40, parent part 40_{Parent} and child part 40_{Child}, the analyzer 120 may then populate 1006 the validation set 30 with the part classification/availability data.

A common part may be, for example, a mass-produced, off-the-shelf part, such as, for example, threaded fastener. If, for example, the commonality indicator classifies one or more of the part 40, parent part 40_{Parent} and child part 40_{Child} as a common part, the inventory data may indicate, for example, that one or more of the part 40, parent part 40_{Parent} and child part 40_{Child} is available 1004 on an on-demand basis.

An uncommon part may be, for example, a non-off-the-shelf part. A non-off-the-shelf part may include, for example, a part that is not mass-produced, but, rather, may be manually manufactured by hand/is available 1004 on a per-order basis. Because an uncommon part may not be readily available on an on-demand basis, the part inventory database 204 may include date-of-availability information (i.e., in some circumstances, the uncommon part may be available, for example, two weeks after being ordered and not on an on-demand basis). Accordingly, by indicating that one or more of the part 40, parent part 40_{Parent} and child part 40_{Child} may be an uncommon part, the classification of one or more of the part 40, parent part 40_{Parent} and child part 40_{Child} as an uncommon part may be utilized in order to qualify the inventory data for the purpose of forecasting when an uncommon part may be/will be available 1004; by communicating 1006 a forecast of part availability 1004, an increase in predictability of task completion may be realized such that one is not waiting for the uncommon part to become available, which may otherwise inhibit completion of an assembly task that requires the uncommon part.

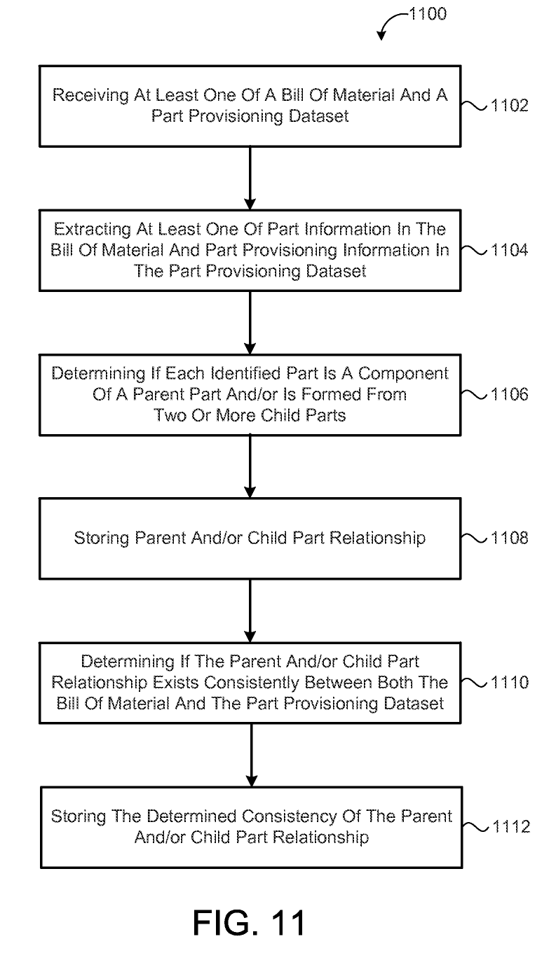

Referring to FIG. 11, an exemplary method 1100 is described. A parser 110 of a validation system 100 receives 1102 one or more of a bill of material 10 (e.g., as a data file) and a part provisioning dataset 20. The parser 110 identifies and/or extracts 1104 one or more of part information 12 from the bill of material 10 and part provisioning information 22 from the part provision dataset 20. For example, the parser 110 may iteratively step through and extract 1104 each item of the bill of material 10 (e.g., each record of a recordset 300, each line of a text file, etc.) and identify each part 40 located in the bill of material 10 and any accompanying information, such as, for example: a part number 304a, part description 304b, Contractor and Government Entity (CAGE) code 304e, part quantity 304c, and/or a parent-child relationship 304d with another part (e.g., for assemblies and subassemblies). Similarly, the parser 110 may identify and/or extract 1104 part provisioning information 22, such as, for example: a stocking number (e.g., national stocking number) 308a, descriptions 3080b, part quantities 308c, and/or parent-child relationships 308d of parts (e.g., assemblies and subassemblies).

The recordset 300 (provided from thereby parser 110 to the analyzer 120 as a result of the extraction step 1102) may be a document object model (DOM), an extensible markup language (XML) object or file, and/or a JavaScript object notation (JSON) object containing the parsed information 304a-304e, 308a-308d. Additionally or alternatively, the parser 110 may store the recordset 300 containing the parsed information 304a-304e, 308a-308d in memory 150 (the memory 150 may be located within, for example, the computing device 5) and/or a database. In some implementations, the recordset 300 may be referred to as a parsed data file. The recordset 300 may be alternatively referred to as a part information recordset 300a or a part provisioning information recordset 300b. From the bill of material 10, the parser 110 may provide a part information recordset 300a having part records 302 with corresponding fields 304. Each part record 302 may include, but is not limited to including, for example: a part number 304a, a part description 304b, a part quantity 304c, a parent-child relationship 304d, and/or a CAGE code 304e. From the part provisioning dataset 20, the parser 110 may provide a part provisioning information recordset 300b having part provisioning records 306 with corresponding fields 308. Each part provisioning record 306 may include, but is not limited to including, for example: a stocking number 308a, a description 308b, a part quantity 308c, and/or a parent-child relationship 308d.

The parser 110 may iteratively step through the bill of material 10 and the part provisioning dataset 20 to determine 1106 if each part 40 is a component of a parent part 40_{Parent} and/or if two or more child parts 40_{Child} forms each part 40. Upon determining a parent relationship or a child relationship of the part 40, the parser 110 may then store 1108 the parent-child relationship (e.g., by storing a part ID or reference ID in a parent field and/or a child field, respectively) in memory 150. The analyzer 120 may then access the stored parent-child relationship in memory 150 in order to determine 1110 if any identified parent part 40_{Parent} and/or any identified child part 40_{Child} exists consistently in both the bill of material 10 and the part provisioning dataset 20. The analyzer 120 may store 1112 an indication of whether the parent-child relationships are correct or inconsistent in memory 150.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of validating data, the method comprising:
receiving, at a computing processor, a bill of material and a part provisioning dataset;
extracting and storing in non-transitory memory at least one of part information from the bill of material or part provisioning information from the part provisioning dataset;
comparing, at the computing processor, the part information to the part provisioning information; and
executing a comparison algorithm on the computing processor for determining a compatibility between the part information and the part provisioning information.

2. The method of claim 1, further comprising storing an indicator of compatibility in the non-transitory memory for a compatibility between the part information and the part provisioning information.

3. The method of claim 1, further comprising communicating to a validation set a compatibility between the part information and the part provisioning information.

4. The method of claim 1, further comprising, if the part information is compatible with the part provisioning information, communicating to a validation set that at least one part in the part information is properly identified with a corresponding at least one part in the part provisioning information.

5. The method of claim 1, further comprising if the part information is incompatible with the part provisioning information, communicating to a validation set that at least one part in the part information is erroneously identified with a corresponding at least one part in the part provisioning information.

6. The method of claim 1, further comprising, if the part information is compatible with the part provisioning information, communicating to a validation set that at least one part of a part tree in the part information is properly identified with a corresponding at least one part of a part tree in the part provisioning information.

7. The method of claim 1, further comprising, if the part information is incompatible with the part provisioning information, communicating to a validation set that at least one part of a part tree in the part information is/are not properly identified with a corresponding at least one part of a part tree in the part provisioning information.

8. The method of claim 1, further comprising, if the part information is compatible with the part provisioning information, communicating a reconciled part quantity to a part database.

9. The method of claim 8, further comprising communicating to a validation set at least one of a cost of one or more parts or an availability of the one or more parts.

10. A method of validating data, the method comprising:
receiving a bill of material and a part provisioning dataset into non-transitory memory;
extracting, at a computing processor, data related to at least one part identified in the bill of material and the part provisioning dataset;
determining, at the computing processor, if the extracted data related to the at least one part includes a parent-child relationship;
determining, at the computing processor, if the parent-child relationship exists consistently in both the bill of material and the part provisioning dataset; and
storing in the non-transitory memory an indicator of consistency of the parent-child relationship between the bill of material and the part provisioning dataset.

11. The method of claim 10, further comprising, after determining if the parent-child relationship exists consistently, storing the parent-child relationship in the non-transitory memory.

12. A validation system comprising:
a file receiver executing on a computing processor, the file receiver receiving and storing in non-transitory memory part information from a bill of material and part provisioning information from a part provisioning dataset; and
a validator executing on the computing processor, the validator receiving an indicator of compatibility of the part information with the part provisioning information from the file receiver.

13. The validation system of claim 12, wherein the file receiver comprises a parser that receives the bill of material and the part provisioning dataset and subsequently parses the received bill of material and the received part provisioning dataset for determining the part information and the part provisioning information.

14. The validation system of claim 13, further comprising an analyzer executing on the computing processor that determines the indicator of compatibility of the part information with the part provisioning information from the file receiver and subsequently communicates the indicator of compatibility to the validator.

15. The validation system of claim 14, further comprising non-transitory memory communicatively-coupled to at least one of the parser or the analyzer for storing the indicator of compatibility.

16. The validation system of claim 15, further comprising a part database communicatively-coupled to the analyzer for communicating from the part database to the analyzer at least one of a cost of one or more parts or an availability of the one or more parts.

17. The validation system of claim 16, wherein the part database includes
a part cost database portion; and
a part supply database portion.

18. A computer program product encoded on a computer readable storage medium comprising instructions that when executed by a data processing apparatus cause the data processing apparatus to perform operations comprising:
receiving a bill of material and a part provisioning dataset;
extracting and storing in non-transitory memory at least one of part information from the bill of material or part provisioning information from the part provisioning dataset;
comparing the part information to the part provisioning information; and
executing a comparison algorithm on a computing processor for determining a compatibility between the part information and the part provisioning information.

19. The computer program product of claim 18, wherein the operations further comprise storing an indicator of compatibility in the non-transitory memory for a compatibility between the part information and the part provisioning information.

20. The computer program product of claim 18, wherein the operations further comprise communicating to a validation set a compatibility between the part information and the part provisioning information.

21. The computer program product of claim 18, wherein the operations further comprise if the part information is compatible with the part provisioning information, communicating to a validation set that at least one part in the part information is properly identified with a corresponding at least one part in the part provisioning information.

22. The computer program product of claim 18, wherein the operations further comprise if the part information is incompatible with the part provisioning information, communicating to a validation set that at least one part in the part information is erroneously identified with a corresponding at least one part in the part provisioning information.

23. The computer program product of claim 18, wherein the operations further comprise, if the part information is compatible with the part provisioning information, communicating to a validation set that at least one part of a part tree in the part information is properly identified with a corresponding at least one part of a part tree in the part provisioning information.

24. The computer program product of claim 18, wherein the operations further comprise, if the part information is incompatible with the part provisioning information, communicating to a validation set that at least one part of a part tree in the part information is/are not properly identified with a corresponding at least one part of a part tree in the part provisioning information.

25. The computer program product of claim 18, wherein the operations further comprise, if the part information is compatible with the part provisioning information, communicating a reconciled part quantity to a part database.

26. The computer program product of claim 25, wherein the operations further comprise communicating to a validation set at least one of a cost of one or more parts or an availability of the one or more parts.

27. The computer program product of claim 18, wherein the operations further comprise:
extracting data related to at least one part identified in the bill of material and the part provisioning dataset;
determining if the extracted data related to the at least one part includes a parent-child relationship;
determining if the parent-child relationship exists consistently in both the bill of material and the part provisioning dataset; and
storing an indicator of consistency of the parent-child relationship between the bill of material and the part provisioning dataset.

28. The computer program product of claim 27, wherein the operations further comprise, after determining if the parent-child relationship exists consistently, storing the parent-child relationship in the non-transitory memory.
